(19) United States
(12) Patent Application Publication
(10) Pub. No.: US 2024/0055735 A1
(43) Pub. Date: Feb. 15, 2024

(54) BATTERY

(71) Applicant: Panasonic Intellectual Property Management Co., Ltd., Osaka (JP)

(72) Inventor: EIICHI KOGA, Osaka (JP)

(21) Appl. No.: 18/487,067

(22) Filed: Oct. 14, 2023

Related U.S. Application Data
(63) Continuation of application No. PCT/JP2022/006555, filed on Feb. 18, 2022.

(30) Foreign Application Priority Data
May 10, 2021 (JP) 2021-080072

(51) Int. Cl. H01M 50/534; H01M 50/533

(52) U.S. Cl. CPC H01M 50/534; H01M 50/533

(57) ABSTRACT

A battery according to a first embodiment includes: a battery element including a first electrode, a solid electrolyte layer, and a second electrode; a first terminal containing a first conductive material; and a second terminal containing a second conductive material. The first terminal is in contact with the first electrode. The second terminal covers at least part of a surface of the first terminal to be electrically connected to the first terminal and directly covers at least part of a corner of the battery element.

### BACKGROUND

### 1. Technical Field

The present disclosure relates to a battery.

### 2. Description of the Related Art

International Publication No. 2018/186449 discloses a surface-mount battery including: a laminate structure including a first electrode, a solid electrolyte layer, and a second electrode; a protective layer covering side surfaces of the laminate structure; and an outer case housing the laminate structure covered by the protective layer. Japanese Unexamined Patent Application Publication No. 2020-87588 discloses a surface mountable electronic component in which metal caps are attached to end surface electrodes.

### SUMMARY

One non-limiting and exemplary embodiment provides a battery having improved reliability.

In one general aspect, the techniques disclosed here feature a battery including: a battery element including a first electrode, a solid electrolyte layer, and a second electrode; a first terminal containing a first conductive material; and a second terminal containing a second conductive material, wherein the first terminal is in contact with the first electrode, the second terminal covers at least part of a surface of the first terminal to be electrically connected to the first terminal and directly covers at least part of a corner of the battery element.

The present disclosure can improve battery reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIGS. 1A and 1B each illustrate a schematic configuration of a battery according to a first embodiment;

FIGS. 2A and 2B each illustrate a schematic configuration of a battery according to a second embodiment;

FIGS. 3A and 3B each illustrate a schematic configuration of a battery according to a third embodiment;

FIGS. 4A and 4B each illustrate a schematic configuration of a battery according to a fourth embodiment; and

FIGS. 5A and 5B each illustrate a schematic configuration of a battery according to a fifth embodiment.

### DETAILED DESCRIPTIONS

Hereinafter, embodiments of the present disclosure will be described in detail with reference to the drawings.

The embodiments described below are all general or specific examples. The numbers, shapes, materials, components, and positions and connections between the components in the following embodiments are examples and should not be construed as limiting of the disclosure.

In this specification, terms indicating relationships between components, such as parallel, terms indicating shapes of components, such as cuboidal, and numerical ranges are not strictly limited to them. They may include approximation, for example, variations of a few percentages.

The drawings are not necessarily strictly to scale. In the drawings, the same reference numerals are assigned to the components having substantially the same configuration without duplicated or detailed explanation.

In the specification and the drawings, the x, y, and z axes are three axes of a three-dimensional orthogonal coordinate system. In the embodiments, the z axis direction corresponds to the thickness direction of the battery. In the specification, the “thickness direction” is a direction perpendicular to the surfaces of the laminated layers of the battery element, unless otherwise specified.

In the specification, when the battery is viewed in “plan view”, the battery is viewed in the direction of lamination in the battery element, unless otherwise specified. In this specification, the “thickness” is a dimension of the battery element and the layers that is measured in the direction of lamination, unless otherwise specified.

In this specification, unless otherwise specified, “side surfaces” of the battery element are surfaces extending in the direction of lamination, and “main surfaces” of the battery element are surfaces other than the side surfaces.

In this specification, “inner” and “outer” in “inner side” and “outer side”, for example, refer to “inner” and “outer” of the battery viewed in the direction of lamination in the battery.

In the specification, the terms “upper” and “lower” used for the configuration of the battery are not meant to refer to the upward direction (vertically upward) and the downward direction (vertically downward) in absolute spatial awareness. The terms are meant to refer to the relative positional relationship based on the lamination order in the lamination configuration. Furthermore, the terms “above” and “below” are used not only for a case where two components are positioned close to each other and in contact with each other but also for a case where two components are spaced apart from each other with another component being interposed therebetween.

### First Embodiment

A battery according to a first embodiment includes: a battery element including a first electrode, a solid electrolyte layer, and a second electrode; a first terminal containing a first conductive material; and a second terminal containing a second conductive material. The first terminal is in contact with the first electrode. The second terminal covers at least part of a surface of the first terminal to be electrically connected to the first terminal and directly covers at least part of an end portion of the battery element. Here, the phrase “the second terminal directly covers at least part of an end portion of the battery element” means that the second terminal is in contact with and covers at least part of an end portion of the battery element. When the battery element has a lamination structure including, in this order, the first electrode, the solid electrolyte layer, and the second electrode, the end portion of the battery element is, for example, an outer peripheral portion of the battery element including side surfaces of the battery element.

In the battery according to the first embodiment, the terminal electrically connected to the first electrode (hereinafter referred to as a “terminal of the first electrode”) has a multilayer structure including the first terminal and the second terminal. The second terminal is located outward from the first terminal and is in contact with both the first terminal and the end portion of the battery element. With this configuration, in the battery according to the first embodiment, the terminal of the first electrode has a complex joint structure composed of the first terminal, the second terminal, and the end portion of the battery element. This complex joint structure provides strong connection between the battery element, the first terminal, and the second terminal, resulting in a strong connection between these components at the end portions of the battery element. Thus, the volume change caused by charge and discharge or temperature cycling is reduced, and thus deformation of the battery is reduced, improving the battery reliability.

Furthermore, with the above-described complex joint structure, the battery according to the first embodiment can have high electrical bonding between the terminal of the first electrode and the battery element. Thus, the battery according to the first embodiment is highly capable of charging and discharging at a high current, i.e., high-rate charge and discharge. Hereafter, high-rate charge and discharge characteristics is referred to as “high-rate characteristics” in some cases.

Furthermore, with the complex joint structure described above, the end portion of the battery element can have strong connection between the components of the battery element and strong connection between the battery element and the terminal, allowing the end areas of the battery element, which are chamfered and removed in conventional configurations, to remain. Thus, in the battery according to the first embodiment, the battery element can have the active material at the end areas, increasing the capacity of the battery.

As described above, the complex joint structure composed of the battery element, the first terminal, and the second terminal enables the battery according to the first embodiment to have not only reliability, such as reduction in deformation caused by charge and discharge or temperature cycling, but also increased capacity and improved high-rate characteristics.

As described in “Description of the Related Art”, International Publication No. 2018/186449 discloses a surface-mount battery that has the protective layer on the side surfaces of the laminate structure including the first electrode, the solid electrolyte layer, and the second electrode, and the laminate structure and the protective layer are housed in the outer case. The protective layer and the outer case reduce entry of moisture into the battery. The improvement in the battery reliability, which is an object of the present disclosure, is achieved, desirable, by reducing a decrease in reliability due to deformation stress caused by charge and discharge or temperature cycling, while extracting battery characteristics as much as possible, such as high-rate charge and discharge and/or high capacity. To achieve this, as in the battery according to the above-described first embodiment, in the battery of the present disclosure, the terminal of the first electrode of the battery element includes the first and second terminals, and the battery has the above-described complex joint structure composed of the battery element, the first terminal, and the second terminal. The battery disclosed in International Publication No. 2018/186449 does not have a complex joint structure between the battery element and the terminal like the one in the battery of the present disclosure. Thus, the battery disclosed in International Publication No. 2018/186449 decreases in reliability when the volume is changed by charge and discharge or temperature cycling. Thus, long-term use of the battery may be difficult and improvement in capacity and high-rate characteristics, which can be achieved by the battery of the present disclosure, may also be difficult. Japanese Unexamined Patent Application Publication No. 2020-87588 discloses a surface mountable electronic component in which metal caps are attached to the end surface electrodes. However, as in International Publication No. 2018/186449, metal caps are attached to the end surface electrodes to prevent entry of moisture. Thus, the electronic components disclosed in Japanese Unexamined Patent Application Publication No. 2020-87588 decreases in reliability due to volume change caused by charge and discharge or temperature cycling, and thus long-term use of the battery is difficult as the battery disclosed in International Publication No. 2018/186449. Furthermore, it also may be difficult for the electronic component disclosed in Japanese Unexamined Patent Application Publication No. 2020-87588 to achieve improvements in capacity and high-rate characteristics, which can be achieved by the battery of the present disclosure.

The battery according to the first embodiment may further include a third terminal containing a third conductive material and a fourth terminal containing a fourth conductive material. The third terminal is in contact with the second electrode. The fourth terminal covers at least part of a surface of the third terminal to be electrically connected to the third terminal and directly covers at least part of an end portion of the battery element. Specifically, in the battery according to the first embodiment, the terminal electrically connected to the second electrode (hereinafter referred to as a “terminal of the second electrode”) may have the same configuration as the terminal of the first electrode. Hereinafter, examples of configurations of the batteries according to the first to fifth embodiments will be described in which the terminal of the second electrode has the same configuration as the terminal of the first electrode, i.e., the terminals of both electrodes have the multilayer structure described above.

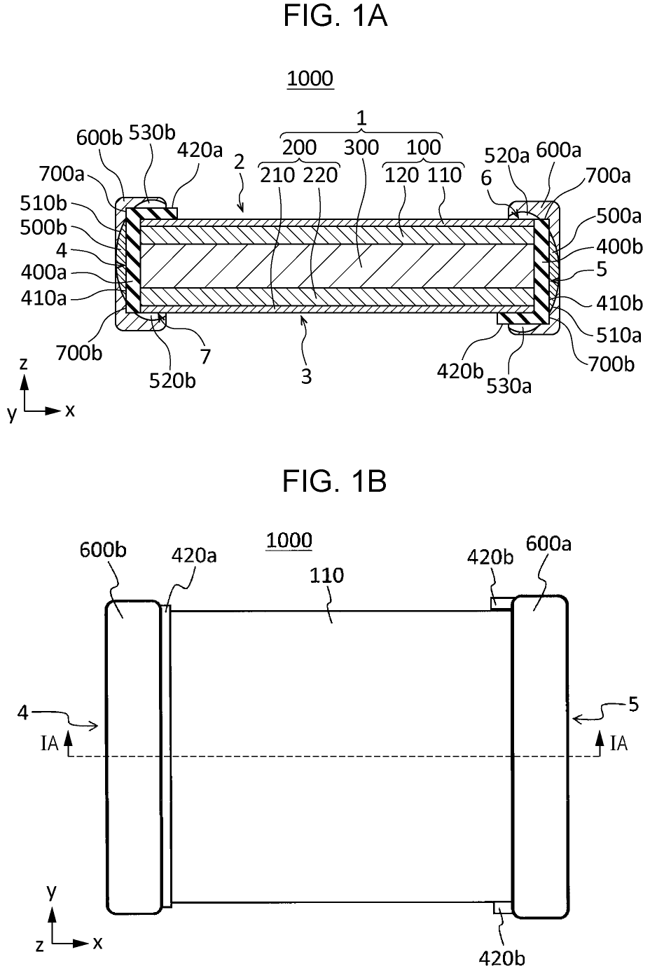

FIGS. 1A and 1B each illustrate a schematic configuration of a battery 1000 according to a first embodiment. FIG. 1A is a cross-sectional view illustrating a schematic configuration of the battery 1000 according to the first embodiment viewed in the y axis direction. FIG. 1B is a plan view illustrating a schematic configuration of the battery 1000 viewed in the z axis direction from above. FIG. 1A illustrates a cross section taken along line IA-IA in FIG. 1B.

As illustrated in FIG. 1A, the battery 1000 includes a battery element 1 including: a first electrode 100, a second electrode 200, and a solid electrolyte layer 300; a first terminal 500a being in contact with the first electrode 100; a second terminal 600a; a third terminal 500b being in contact with the second electrode 200; and a fourth terminal 600b. The second terminal 600a covers at least part of a surface of the first terminal 500a to be electrically connected to the first terminal 500a and directly covers at least part of an end portion of the battery element 1. The fourth terminal 600b covers at least part of a surface of the third terminal 500b to be electrically connected to the third terminal 500b and directly covers at least part of an end portion of the battery element 1. The battery element 1 further includes a first insulating member 400a, which insulates the first electrode 100 at an end portion of the battery element 1, and a second insulating member 400b, which insulates the second electrode 200 at an end portion of the battery element 1, at the end portions of the battery element 1 including the side surfaces of the battery element 1, for example. The second terminal 600a is in contact with and covers the end portion of the battery element 1 with the second insulating member 400b interposed therebetween. The fourth terminal 600b is in contact with and covers the end portion of the battery element 1 with the first insulating member 400a interposed therebetween. The battery element 1 has a structure in which the first electrode 100, the solid electrolyte layer 300, and the second electrode 200 are laminated in this order.

The battery 1000 is, for example, an all-solid-state battery.

Hereafter, the first insulating member 400a and the second insulating member 400b may be collectively and simply referred to as an “insulating film”. Furthermore, the third terminal 500b differs from the first terminal 500a in that it is in contact with the second electrode 200 instead of the first electrode 100, but the third terminal 500b has substantially the same function and effect as the first terminal 500a. Thus, hereinafter, the explanation of the first terminal 500a is also applicable to the third terminal 500b. Furthermore, the fourth terminal 600b differs from the second terminal 600a in that it is electrically connected to the second electrode 200 instead of the first electrode 100, but the fourth terminal 600b has substantially the same function and effect as the second terminal 600a. Thus, hereinafter, the explanation of the second terminal 600a is applicable to the fourth terminal 600b.

In the battery 1000, the battery element 1 is composed of one cell.

An example of the shape of the battery element 1 is a cuboid. Other examples of the shape of the battery element 1 include a cylindrical shape and a polygonal columnar shape.

Surfaces of the battery element 1 include a first main surface 2 having the first electrode 100, a second main surface 3 opposite the first main surface 2 and having the second electrode 200, and side surfaces. The side surfaces of the battery element 1 include four surfaces, which are two sets of two opposing surfaces. The side surfaces of the battery element 1 include a first side surface 4 and a second side surface 5, which are short-side surfaces in plan view.

The first and second main surfaces 2 and 3 extend in a direction perpendicular to the thickness direction of the battery element 1. The first main surface 2 has a first electrode exposed region 6, which is not covered by both the second insulating member 400b and the first terminal 500a, at a position overlapping the second main surface 3 (described below) in plan view. The second main surface 3 has a second electrode exposed region 7, which is not covered by both the first insulating member 400a and the third terminal 500b, at a position overlapping the first main surface 2 (described below) in plan view.

The first side surface 4 and the second side surface 5 each extend from the outer edges of the first main surface 2 to the outer edges of the second main surface 3 in a direction intersecting the first main surface 2 and connect the first main surface 2 and the second main surface 3 to each other. The first side surface 4 and the second side surface 5 extend in the thickness direction of the battery element 1. For example, the first side surface 4 and the second side surface 5 are opposed to each other.

At least part of a surface of the battery element 1, e.g., at least part of at least one surface selected from the group consisting of the first main surface 2, the second main surface 3, the first side surface 4, and the second side surface 5 may be roughened to improve adhesion with the first or second terminal. For example, after at least part of the surface of the battery element 1 is abraded with #800 to #1000 abrasive paper to be roughened, the first terminal, the second terminal, and the insulating film may be formed by coating.

The surface of the first terminal 500a in contact with the second terminal 600a may be roughened. The surface roughness in this case has, for example, a maximum height Rz of greater than or equal to 10 μm and less than or equal to 20 μm. This allows dispersion of the surface energy of the battery element 1 and can reduce the influence of surface tension. Thus, wettability during coating becomes higher, improving the accuracy of the shape. This improves the position accuracy of the first terminal 500a, the second terminal 600a, and the second insulating member 400b, reducing the possibility of short-circuiting in the battery 1000. The surface area of the battery element 1 increases as the surface roughness increases. This improves connection between the surfaces of the battery element 1 and the first and second terminals 500a and 600a.

In FIG. 1A, a first current collector 110, a first active material layer 120, the solid electrolyte layer 300, a second current collector 210, and a second active material layer 220 are the same in shape, position, and size in plan view. The first current collector 110, the first active material layer 120, the solid electrolyte layer 300, the second current collector 210, and the second active material layer 220 may differ from each other in shape, position, and size in plan view. For example, in plan view, the second active material layer 220 may be larger than the first active material layer 120. The solid electrolyte layer 300 may be larger than the first active material layer 120 and the second active material layer 220. Furthermore, the solid electrolyte layer 300 may cover the side surfaces of the first active material layer 120 and the second active material layer 220 and may be in contact with the first current collector 110 and the second current collector 210.

As described above, the battery element 1 includes the first electrode 100, the second electrode 200, and the solid electrolyte layer 300. The solid electrolyte layer 300 is located between the first electrode 100 and the second electrode 200.

The first electrode 100 includes the first current collector 110 and the first active material layer 120. The first current collector 110 may be in contact with the first active material layer 120. The first electrode 100 may further include a layer, such as a bonding layer composed of a conductive material, between the first current collector 110 and the first active material layer 120.

The first electrode 100 does not necessarily have to include the first current collector 110. For example, a terminal for extraction or a substrate supporting the battery 1000 may be electrically connected to the first active material layer 120 to serve as a current collector. The first electrode 100 may be composed solely of the first active material layer 120.

The second electrode 200 includes the second current collector 210 and the second active material layer 220. The second current collector 210 may be in contact with the second active material layer 220. The second electrode 200 may further include a layer, such as a bonding layer composed of a conductive material, between the second current collector 210 and the second active material layer 220.

The second electrode 200 does not necessarily have to include the second current collector 210. For example, a terminal for extraction or a substrate supporting the battery 1000 may be electrically connected to the second active material layer 220 to serve as a current collector. The second electrode 200 may be composed solely of the second active material layer 220.

The first electrode 100 may be a positive electrode. In this case, the first current collector 110 is a positive electrode current collector, and the first active material layer 120 is a positive electrode active material layer.

In this case, the second current collector 210 is a negative electrode current collector, and the second active material layer 220 is a negative electrode active material layer.

Hereafter, the first active material layer 120 and the second active material layer 220 are referred to simply as “active material layers” in some cases. The first current collector 110 and the second current collector 210 are referred to simply as “current collectors” in some cases.

The current collector only needs to be formed of a conductive material. The current collector may be formed of any material. Examples of the material of the current collector include stainless steel, nickel, aluminum, iron, titanium, copper, palladium, gold, platinum, and an alloy of two or more of these. Examples of the shape of the current collector include a foil-like shape, a plate-like shape, and a mesh-like shape. The material of the current collector may be selected as appropriate in view of the manufacturing process, the operating temperature, the possibility of melting and degrading under operating pressure, the battery operating potential applied to the collector, and the conductivity. The material of the current collector may also be selected according to the required tensile strength and heat resistance. The current collector may be a high-strength electrolytic copper foil or a clad material including laminated dissimilar metal foils.

The thickness of the current collector may be greater than or equal to 10 μm and less than or equal to 100 μm. The current collector having a thickness of less than 10 μm can be employed if it satisfies the handling properties in the manufacturing process, the characteristic aspects, such as a current capacity, and the reliability.

The positive electrode active material layer contains a positive electrode active material. A positive electrode active material is a substance in which metal ions, such as lithium (Li) ions and magnesium (Mg) ions, are inserted into or removed from the crystal structure at a higher potential than the negative electrode, and is oxidized or reduced accordingly. The type of positive electrode active material is appropriately selected depending on the type of battery, and any known positive electrode active material can be used.

The positive electrode active material may be a compound containing lithium and a transition metal element. Specifically, examples of the compound include an oxide containing lithium and a transition metal element and a phosphate compound containing lithium and a transition metal element. Examples of the oxide containing lithium and a transition metal element include a lithium nickel composite oxide, such as LiNiₓM₁₋ₓO₂ (where M is at least one element selected from the group consisting of Co, Al, Mn, V, Cr, Mg, Ca, Ti, Zr, Nb, Mo, and W, and x satisfies 0<x≤1), a layered oxide, such as lithium cobalt oxide (LiCoO₂), lithium nickel oxide (LiNiO₂), and lithium manganese oxide (LiMn₂O₄), and lithium manganese oxide having a spinel structure (LiMn₂O₄, Li₂MnO₃, LiMnO₂). An example of the phosphate compound containing lithium and a transition metal element is lithium iron phosphate having an olivine structure (LiFePO₄). Other examples of the positive electrode active material include sulfur (S) and sulfides, such as lithium sulfide (Li₂S). When the positive electrode active material is sulfide, lithium niobate (LiNbO₃) or the like may coat or may be added to the positive electrode active material particles. Only one of these materials may be used as the positive electrode active material, or two or more of these materials may be used in combination.

The positive electrode active material layer may contain an additive in addition to the positive electrode active material. In other words, the positive electrode active material layer may be a composite layer. Examples of the additive include solid electrolytes, such as inorganic solid electrolytes and sulfide solid electrolytes, conductive aids, such as acetylene black, and bonding binders, such as polyethylene oxide and polyvinylidene fluoride. The positive electrode active material layer in which the positive electrode active material and the additive are mixed in a predetermined rate can have higher lithium-ion conductivity and higher electron conductivity in the positive electrode active material layer. The solid electrolyte may be, for example, a solid electrolyte exemplified as a material of the solid electrolyte layer 300 described below.

The thickness of the positive electrode active material layer may be, for example, greater than or equal to 5 μm and less than or equal to 300 μm.

The negative electrode active material layer contains a negative electrode active material. A negative electrode active material is a substance in which metal ions, such as lithium (Li) ions and magnesium (Mg) ions, are inserted into or removed from the crystal structure at a lower potential than the positive electrode, and is oxidized or reduced accordingly. The type of negative electrode active material is appropriately selected depending on the type of battery, and any known negative electrode active material can be used.

Examples of the negative electrode active material include a carbon material, such as natural graphite, artificial graphite, graphite carbon fiber, and resin heat-treated carbon, and an alloy-based material that forms a composite material with the solid electrolyte. Examples of the alloy-based materials include lithium alloys, such as LiAl, LiZn, Li₃Bi, Li₃Cd, Li₃Sb, Li₄Si, Li_{4.4}Pb, Li_{4.4}Sn, Li_{0.17}C, and LiC₆, oxides of lithium and a transition metal element, such as lithium titanate (Li₄Ti₅O₁₂), and metal oxides, such as zinc oxide (ZnO) and silicon oxide (SiOₓ). One of these materials may be solely used as the negative electrode active material, or two or more of these materials may be used in combination.

The negative electrode active material layer may contain an additive in addition to the negative electrode active material. In other words, the negative electrode active material layer may be a composite layer. Examples of the additive include solid electrolytes, such as inorganic solid electrolytes and sulfide solid electrolytes, conductive aids, such as acetylene black, and bonding binders, such as polyethylene oxide and polyvinylidene fluoride. The negative electrode active material layer in which the negative electrode active material and the additive are mixed in a predetermined rate can have higher lithium-ion conductivity and higher electron conductivity in the negative electrode active material layer. The solid electrolyte may be, for example, a solid electrolyte exemplified as a material of the solid electrolyte layer 300 described below.

The thickness of the negative electrode active material layer may be, for example, greater than or equal to 5 μm and less than or equal to 300 μm.

The solid electrolyte layer 300 is located between the first active material layer 120 and the second active material layer 220. The solid electrolyte layer 300 may be in contact with the first active material layer 120 and the second active material layer 220.

The solid electrolyte layer 300 contains a solid electrolyte. The solid electrolyte layer 300 contains, for example, a solid electrolyte as a main component. The solid electrolyte may be any known battery solid electrolyte that has no electron conductivity but has ion conductivity. The solid electrolyte may be a solid electrolyte that conducts metal ions, such as lithium ions and magnesium ions. The solid electrolyte may be selected as appropriate depending on the kind of ions conducted. Examples of the solid electrolyte include sulfide solid electrolytes, oxide solid electrolytes, and halide solid electrolytes.

Examples of the sulfide solid electrolytes include Li₂S—P₂S₅ system, Li₂S—SiS₂ system, Li₂S—B₂S₃ system, Li₂S—GeS₂ system, Li₂S—SiS₂—LiI system, Li₂S—SiS₂—Li₃PO₄ system, Li₂S—Ge₂S₂ system, Li₂S—GeS₂—P₂S₅ system, and Li₂S—GeS₂—ZnS system.

Examples of the oxide solid electrolytes include lithium-containing metal oxides, such as Li₂O—SiO₂ and Li₂O—SiO₂—P₂O₅, lithium-containing metal nitrides, such as LiₓP_{y}O_{1-z}N_{z}, garnet-type solid electrolytes, such as Li₇La₃Zr₂O₁₂ and elemental substitutes thereof, and lithium-containing transition metal oxides, such as lithium phosphate (Li₃PO₄) and lithium titanium oxide.

An example of the halide solid electrolyte is a compound represented by LiₐMe_{b}Y_{c}Z₆. In the formula, a+mb+3c=6 and c>0 are satisfied. Me is at least one selected from the group consisting of metallic elements other than Li and Y and metalloid elements. Z represents at least one selected from the group consisting of F, Cl, Br, and I. The value of m represents the valence of Me.

The “metalloid elements” include B, Si, Ge, As, Sb, and Te. The “metallic elements” are all elements in the groups 1 to 12 of the periodic table (except hydrogen) and all elements in the groups 13 to 16 in the periodic table (except B, Si, Ge, As, Sb, Te, C, N, P, O, S, and Se).

Me may be at least one selected from the group consisting of Mg, Ca, Sr, Ba, Zn, Sc, Al, Ga, Bi, Zr, Hf, Ti, Sn, Ta, and Nb to increase the ionic conductivity of the halide solid electrolyte.

Examples of the halide solid electrolytes include Li₃YCl₆ and Li₃YBr₆.

As a solid electrolyte, one of these materials may be solely used, or two or more of these materials may be used in combination.

The solid electrolyte layer 300 may contain a bonding binder, such as polyethylene oxide and polyvinylidene fluoride, in addition to the solid electrolyte.

The thickness of the solid electrolyte layer 300 may be, for example, greater than or equal to 5 μm and less than or equal to 150 μm.

The solid electrolyte layer 300 may be composed of an aggregate of particles of a solid electrolyte. The solid electrolyte layer 300 may be composed of a sintered structure of a solid electrolyte.

### Insulating Film

The battery 1000 may include an insulating film. As illustrated in FIG. 1A, the side surfaces and the main surfaces of the battery element 1 may be partially covered by an insulating film.

The first insulating member 400a has a first side surface covering portion 410a on the first side surface 4 of the battery element 1 and a first main surface covering portion 420a on the first main surface 2. In FIG. 1A, the first insulating member 400a does not cover the second main surface 3. The first insulating member 400a may cover a part of the second main surface 3 as long as the first insulating member 400a does not prevent contact between the third terminal 500b and the second electrode 200.

The first insulating member 400a, for example, is in contact with the first main surface 2 and covers the end portion of the first main surface 2. The first side surface covering portion 410a extends continuously from the first main surface covering portion 420a. In other words, the first insulating member 400a extends continuously from the first side surface 4 onto the first main surface 2 to continuously cover the ridge between the first side surface 4 and the first main surface 2.

The second insulating member 400b includes a second side surface covering portion 410b on the second side surface 5 of the battery element 1 and a second main surface covering portion 420b on the second main surface 3. In FIG. 1A, the second insulating member 400b does not cover the first main surface 2. The second insulating member 400b may cover a part of the first main surface 2 as long as the second insulating member 400b does not prevent contact between the first terminal 500a and the first electrode 100.

The second insulating member 400b, for example, is in contact with the second main surface 3 and covers the end portion of the second main surface 3. The second side surface covering portion 410b extends continuously from the second main surface covering portion 420b. In other words, the second insulating member 400b extends continuously from the second side surface 5 onto the second main surface 3 to continuously cover the ridge between the second side surface 5 and the second main surface 3.

The first side surface covering portion 410a and the second side surface covering portion 410b also cover a portion of the long-side surface of the battery element 1 (i.e., the xz plane of the battery element 1) in plan view. The first side surface covering portion 410a and the second side surface covering portion 410b may cover all or a portion of the long-side surface of the battery element 1 in plan view. The first and second main surface covering portions 420a and 420b may partly cover the areas along the long sides of the main surface of the battery element 1.

The material of the insulating film may be any electrical insulator. The insulating film contains, for example, a resin material. The insulating film may contain an insulating resin material as the main component. Examples of resins include epoxy resins, acrylic resins, polyimide resins, and silsesquioxane. The material of the insulating film may be a coatable resin material, such as thermosetting epoxy resins in the form of liquid or powder. The coatable resin material in the form of liquid or powder may be applied onto the side surfaces and the main surfaces of the battery element 1 and thermally cured such that an insulating film covers the side surfaces and the main surfaces of the battery element 1 to be bonded and connected to them. The insulating film may have a structure in which multiple insulating layers composed of the same or different materials are laminated.

As described above, the insulating film may also cover a part or the entire of the long-side side surfaces of the battery element 1 in plan view continuously from the corners and the ridges located at the end portions of the first side surface 4 and the second side surface 5 of the battery element 1.

### First Terminal and Third Terminal

The first terminal 500a containing the first conductive material is a film-like conductive member that covers a part of the second insulating member 400b of the battery element 1 from the outside and is electrically connected to the first electrode 100. The second insulating member 400b has a ridge exposed portion 700a, which is not covered by the first terminal 500a, along a portion of the ridge between the second side surface 5 and the first main surface 2. Thus, the first terminal 500a and the ridge exposed portion 700a are covered by the second terminal 600a, which is described below, from the outside and are in contact with and connected to the second terminal 600a. As illustrated in FIG. 1A, the ridge exposed portion 700a may be a corner of the end portion of the battery element 1. In other words, the second terminal 600a may directly cover at least part of a corner of the battery element 1. The battery element 1 is in contact with the second terminal 600a at the corner of the end portion. This results in stronger connection between the battery element 1, the first terminal 500a, and the second terminal 600a, further improving the battery reliability. Here, the corner of the end portion of the battery element 1 is a portion where the side surface of the battery element 1 meets the main surface.

Specifically, the first terminal 500a extends from the outer surface of the second insulating member 400b to the first electrode 100 located at the first main surface 2 to continuously cover at least part of the second insulating member 400b and at least part of the first electrode 100 located at the first main surface 2. However, the first terminal 500a does not cover a part of the ridge of the second insulating member 400b, e.g., the corner, because it is the ridge exposed portion 700a. The first terminal 500a covers the end portion of the battery element 1 from the outside. The first terminal 500a also covers the second side surface 5 and the second main surface 3 of the battery element 1 with the insulating film interposed therebetween. The first terminal 500a may be in contact with the side surface of the battery element 1 in this way as long as the first terminal 500a is not in contact with the second electrode 200.

The first terminal 500a has a second side surface covering portion 510a covering the second side surface covering portion 410b of the second insulating member 400b, an electrode contact portion 520a in contact with the first main surface 2, and a second main surface covering portion 530a. The second side surface covering portion 510a, the electrode contact portion 520a, and the second main surface covering portion 530a may be continuous, except for the ridge exposed portion 700a, which is the exposed portion of the second insulating member 400b.

The second side surface covering portion 510a covers the outer surface of the second insulating member 400b. The second side surface covering portion 510a, for example, is in contact with the outer surface of the second insulating member 400b and is bonded to the electrode contact portion 520a and the second main surface covering portion 530a. The second side surface covering portion 510a of the first terminal 500a covers the second side surface covering portion 410b.

As illustrated in FIG. 1A, in the first terminal 500a, the second side surface covering portion 510a covers the second side surface covering portion 410b of the second insulating member 400b, the electrode contact portion 520a is in contact with a part of the first electrode 100 located at the first main surface 2 (here a part of the first current collector 110), and the second main surface covering portion 530a covers a part of the second main surface covering portion 420b from the outside.

In other words, the first terminal 500a extends from the outer surface of the second side surface covering portion 410b of the second insulating member 400b to the outer surface of the second main surface covering portion 420b to cover a part of the second main surface covering portion 420b of the second insulating member 400b and extends from the outer surface of the second side surface covering portion 410b to the first electrode 100 located at the first main surface 2 to be in contact with the first electrode 100. In plan view, the inner edge of the second main surface covering portion 530a is located outward from the inner edge of the second main surface covering portion 420b. The second main surface covering portion 530a does not need to cover the entire second main surface covering portion 420b.

The electrode contact portion 520a of the first terminal 500a covers at least part of the first main surface 2 and is bonded to the first main surface 2. In other words, the electrode contact portion 520a is electrically connected to the first electrode 100. The electrode contact portion 520a is, for example, electrically connected to the current collector 110. The electrode contact portion 520a is, for example, in contact with the first electrode exposed region 6 of the first main surface 2. In this configuration, the electrode contact portion 520a is in contact with the first electrode exposed region 6, which is located near the end portion of the first main surface 2 adjacent to the first terminal 500a. This eliminates the need for the first terminal 500a to extend a lot to an inner side of the first main surface 2 and enables an electrical connection between the first terminal 500a and the first electrode 100 to be readily established. In plan view, the inner edge of the second main surface covering portion 530a of the first terminal 500a and the inner edge of the electrode contact portion 520a are located at the same position, for example.

The third terminal 500b has a structure substantially the same as that of the above-described first terminal 500a. The third terminal 500b containing the third conductive material is a film-like conductive member that covers a part of the first insulating member 400a of the battery element 1 from the outside and is electrically connected to the second electrode 200. The first insulating member 400a has a ridge exposed portion 700b, which is not covered by the third terminal 500b, along a part of the ridge between the first side surface 4 and the second main surface 3. Thus, the third terminal 500b and the ridge exposed portion 700b are covered by the fourth terminal 600b, which is described below, from the outside and are in contact with and connected to the fourth terminal 600b. As illustrated in FIG. 1A, the ridge exposed portion 700b may be a corner of the end portion of the battery element 1. The battery element 1 is in contact with the fourth terminal 600b at the corner of the end portion. This results in stronger connection between the battery element 1, the third terminal 500b, and the fourth terminal 600b, further improving the battery reliability.

Specifically, the third terminal 500b extends from the outer surface of the first insulating member 400a to the second electrode 200 located at the second main surface 3 to continuously cover at least part of the first insulating member 400a and at least part of the second electrode 200 located at the second main surface 3. The third terminal 500b does not cover a part of the ridge of the first insulating member 400a, e.g., a corner, because it is the ridge exposed portion 700b. The third terminal 500b covers the end portion of the battery element 1 from the outside. The third terminal 500b also covers the first side surface 4 and the first main surface 2 of the battery element 1 with the insulating film interposed therebetween. The third terminal 500b may be in contact with the side surface of the battery element 1 in this way as long as the third terminal 500b is not in contact with the first electrode 100.

The third terminal 500b has a first side surface covering portion 510b covering the first side surface covering portion 410a of the first insulating member 400a, an electrode contact portion 520b in contact with the second main surface 3, and a first main surface covering portion 530b. The first side surface covering portion 510b, the electrode contact portion 520b, and the first main surface covering portion 530b may be continuous, except for the ridge exposed portion 700b, which is the exposed portion of the first insulating member 400a.

The first side surface covering portion 510b covers the outer surface of the first insulating member 400a. The first side surface covering portion 510b is in contact with, for example, the outer surface of the first insulating member 400a and is bonded to the electrode contact portion 520b and the first main surface covering portion 530b. The first side surface covering portion 510b of the third terminal 500b covers the first side surface covering portion 410a.

In FIG. 1A, in the third terminal 500b, the first side surface covering portion 510b covers the first side surface covering portion 410a of the first insulating member 400a, the electrode contact portion 520b is in contact with a part of the second electrode 200 located at the second main surface 3 (here a part of the second current collector 210), and the first main surface covering portion 530b covers a part of the first main surface covering portion 420a from the outside.

In other words, the third terminal 500b extends from the outer surface of the first side surface covering portion 410a of the first insulating member 400a to the outer surface of the first main surface covering portion 420a to cover a part of the first main surface covering portion 420a of the first insulating member 400a and also extends from the outer surface of the first side surface covering portion 410a to the second electrode 200 located at the second main surface 3 to be in contact with the second electrode 200. In plan view, the inner edge of the first main surface covering portion 530b is located outward from the inner edge of the first main surface covering portion 420a. The first main surface covering portion 530b does not necessarily have to cover the entire first main surface covering portion 420a.

The electrode contact portion 520b of the third terminal 500b covers at least part of the second main surface 3 and is bonded to the second main surface 3. In other words, the electrode contact portion 520b is electrically connected to the second electrode 200. The electrode contact portion 520b is electrically connected to the second current collector 210, for example. The electrode contact portion 520b is, for example, in contact with the second electrode exposed region 7 of the second main surface 3. In this configuration, the electrode contact portion 520b is in contact with the second electrode exposed region 7, which is located near the end portion of the second main surface 3 adjacent to the third terminal 500b. This eliminates the need for the third terminal 500b to extend a lot to an inner side of the second main surface 3 and enables an electrical connection between the second terminal 600a and the second electrode 200 to be readily established. In plan view, the inner edge of the first main surface covering portion 530b of the third terminal 500b and the inner edge of the electrode contact portion 520b are located at the same position, for example.

The first terminal 500a and the third terminal 500b may have any thickness. To increase the volumetric energy density of the battery 1000, the thickness of the terminals, particularly at least one of the electrode contact portion 520a or the electrode contact portion 520b may be thinner than the current collector. The thickness of the terminal, particularly the thickness of the electrode contact portion 520a and the thickness of the electrode contact portion 520b is, for example, greater than or equal to 1 μm and less than or equal to 50 μm and may be greater than or equal to 2 μm and less than or equal to 40 μm. When the thickness of the terminals is in the above range, the volumetric energy density is less likely to decrease, and the stress caused by expansion or contraction of the current collector due to a temperature change is reduced, enabling the characteristics of the battery 1000 to be exhibited in a stable manner.

### First Conductive Material and Third Conductive Material

The first conductive material is composed of a conductive material having electron conductivity. To enable high current flow, such as high-rate charge and discharge, the first conductive material may contain a highly conductive metallic material mainly containing, for example, low resistance Ag or copper. For example, an electrode paste containing metal particles is applied and heat treated (e.g., baked) to form the first terminal 500a. In this way, the first conductive material may be a sintered material containing metal. In this configuration, the sintered low-resistance metal film reduces heat generation and burnout, for example, at the connection between the current collector and the first terminal 500a, which is highly likely to become high resistance. Thus, with this configuration, the battery according to the first embodiment is more suitable for high current and can have improved high-rate characteristics and higher reliability. Furthermore, the battery can be strongly connected to the underlying member.

The first conductive material may contain a resin material. This can reduce rapid volume changes caused by high-rate charge and discharge. In addition, this can provide high end-face sealing properties. Thus, this configuration enables high-performance and highly reliable batteries to be produced. For example, the first conductive material may contain a conductive resin material having densely dispersed metal particles to reduce resistance.

The first terminal 500a, which contains a sintered material and/or a conductive resin material, enables the battery to operate at a high rate. Furthermore, the first terminal 500a forms the complex joint structure with the second terminal 600a (described below) covering the first terminal 500a, providing cushioning properties and strong connection while having conductivity. This enables production of batteries that can operate at a high rate and have reliability against volume changes caused by charge and discharge or temperature cycling.

When the first terminal 500a is formed of a sintered material, the sintering temperature may be, for example, about half the melting point of the metal. A sintered conductive film is produced by using particles of a few microns. The decrease in the particle diameter increases the contact area between the particles, which allows a further decrease in the sintering temperature. The sintering temperature may be set in view of the heat resistance of the battery element 1.

To reduce stresses in the battery element 1 caused by expansion or contraction of the layers of the battery element 1 during charge and discharge, the first terminal 500a may be formed of, for example, a conductive resin material in which the above-described metal particles are dispersed at a high density. An increase in the density of metal particles and a decrease in the diameter of the metal particles increase the contact area between the metal particles, which can further reduce the resistance of the relatively soft conductive resin material. A conductive resin material with a high metal content (e.g., greater than or equal to 70% by mass) that includes fine particles containing Ag and/or Cu having a particle diameter of 0.1 μm to 1 μm, for example, may be used as the first conductive material. For example, the first conductive material may have a Young's modulus smaller than that of the metal constituting the first and second current collectors 110 and 210. When a soft material is used as the first conductive material, expansion and contraction caused by high-rate operation and charge-discharge cycles are reduced, and thus reliability at the connection (e.g., joint to the current collector), which is readily likely to be detached, is improved.

To further improve the reliability of the battery 1000, the first conductive material may have a smaller Young's modulus than the solid electrolyte layer 300, the first active material layer 120, and the second active material layer 220. This allows absorption of the deformation stress of the first active material layer 120 and the second active material layer 220, which are the components mainly subjected to expansion and contraction caused by charge and discharge, and suppresses structural defects, improving the reliability of the battery 1000. The first conductive material may contain a resin material to reduce the Young's modulus of the first conductive material.

The Young's modulus relationship can be examined, for example, in terms of the displacement characteristics relative to pressure applied by a probe pressed in, or in terms of the size of the indentation.

The first conductive material may include, for example, silver, copper, nickel, zinc, aluminum, palladium, gold, platinum, or an alloy of any combination of these metals. Alternatively, the first conductive material may be material that contains conductive particles or particles of a semiconductor material in a solid electrolyte. This allows adjustment of the linear expansion coefficient and hardness in relation to the battery element 1, reducing structural defects caused by stress caused by volume changes resulting from, for example, charge and discharge or temperature cycling. This can further improve the reliability of the battery that can operate at a high rate with low loss.

The first conductive material may contain an oxide. In this configuration, the oxide of the first terminal 500a digs into the second terminal 600a at the bonded interface between the first terminal 500a and the second terminal 600a, providing an anchoring effect. This improves the bonding strength between the first terminal 500a and the second terminal 600a. The oxide desirable has a higher hardness than the material to be bonded to the first terminal 500a (e.g., materials of the current collector, the insulating film, and the solid electrolyte layer). Examples of such oxides having high mechanical strength include alumina (Al₂O₃) and zirconia (ZrO₂) The oxide may be in the form of particles. The size of the oxide particles only has to be set within the range of thickness of the first terminal 500a. The first conductive material may be contained in any amount within a predetermined range of conductivity.

The first conductive material may be a sintered material containing glass. In this configuration, the pores in the sintered body are filled with glass components, improving the sealing properties of the first terminal 500a. This reduces entry of moisture into the battery element 1.

The first conductive material may be a sintered material containing two or more kinds of glass. That is, the first conductive material may contain glass frit. The glass frit component is melted by baking and is closely attached to the underlying member (e.g., bumps and dips on the surface of the current collector), improving the bonding strength of the first terminal 500a. Furthermore, a glass frit component may be diffused onto the surface of the current collector to form a reaction layer, such as a diffusion layer and an alloy layer, on the surface of the collector. This can further improve the bonding strength. For example, when the current collector contains Cu, powders of Zn, Al, Sn, Sb, Bi, or the like may be added to the first conductive material at a ratio of 0.1 to 10% by mass to form a reaction layer during baking. Any composition that can form an alloy at a temperature below the baking temperature can be used. Glass frit that is powdered to a few microns, for example, may be contained in metal powders, and the glass component can be melted by heat treatment at a temperature above its softening point, for example. Furthermore, the molten glass component wets the surface of the metal particles and acts as a sintering aid of the metal particles, which further lowers the sintering temperature and the reaction temperature.

The glass contained in the first conductive material may have a compacted powder structure and a molten structure. In this configuration, the compacted powder structure can absorb stress, and the molten structure can improve sealing properties and connection to the underlying member, which prevent entry of moisture and other substances. A glass having such a compacted powder structure and a molten structure can be provided by a glass including, for example, two or more glass compositions having different softening points. For example, in a glass composition region where the softening point is higher than the heat treatment temperature, the glass is not completely sintered by the heat treatment and has a compacted powder structure in which glass powders are in contact with each other. On the other hand, in a glass composition region where the softening point is lower than the heat treatment temperature, the glass has a structure molten by the heat treatment, i.e., a molten structure.

The content of the glass frit in the first conductive material may be any value if it does not destroy the conductivity of the first terminal 500a. For example, the content may be 0.1 to 10% by mass.

The softening point of the glass frit can be controlled mainly by the glass composition. For example, any glass composition may be selected such that the softening point is in a range of 400 to 900° C., for example. Alternatively, the glass frit may contain multiple glass components having different softening points. This allows the glass structure after baking to be a mixed structure including a particulate glass structure (i.e., glass components that were not softened) and a molten glass structure (glass components that were softened). The glass having such a composition including the multiple structures allows the stress caused by temperature cycling or charge and discharge to be absorbed by the deformation of the particulate glass powder structure and allows the connection to be improved by the molten glass structure. This enables formation of the first terminal 500a having high stress absorbency and high connection reliability. This configuration can provide a first terminal 500a that enables charge and discharge at a high rate and can be reliably connected to the battery element 1. To observe the microstructure of the first terminal 500a, the cross section polished by mechanical polishing or by using an ion polishers may be observed by using a scanning electron microscopy (SEM), an optical microscopy (e.g., 1 k to 5 k times), or a laser microscopy. The composition of the microstructure of the first terminal 500a can be analyzed quantitatively and elementally by an electron beam micro analyzer (EPMA) or an energy dispersive X-ray analysis (EDX).

The first terminal 500a may be composed of a conductive resin paste, which allows a wider range of control of the softness (e.g., Young's modulus), to reduce detachment of the conductive film. The resin paste may further contain a constituent of the battery element, such as a solid electrolyte. This allows the linear expansion to be adjusted to be close to that of the battery element, resulting in improved resistance to thermal shock.

The resin that can be contained in the first conductive material may be a thermoplastic resin or a thermosetting resin. The first conductive material may contain a thermosetting resin to enable easy formation of the terminal.

Examples of the thermoplastic resin include polyethylene resin, polypropylene resin, acrylic resin, polystyrene resin, vinyl chloride resin, silicone resin, polyamide resin, polyimide resin, fluorinated hydrocarbon resin, polyether resin, butadiene rubber, isoprene rubber, styrene-butadiene rubber (SBR), styrene-butadiene-styrene copolymer (SBS), styrene-ethylene-butadiene-styrene copolymer (SEBS), ethylene-propylene rubber, butyl rubber, chloroprene rubber, and acrylonitrile-butadiene rubber.

Examples of the thermosetting resins include (i) amino resins, such as urea resin, melamine resin, and guanamine resin; (ii) epoxy resins, such as bisphenol A resin, bisphenol F resin, phenolic novolac resin, and alicyclic resin; (iii) oxetane resins; (iv) resol or novolac phenolic resins, and (v) silicone modified organic resins, such as silicone epoxy resin and silicone polyester resin.

The first terminal 500a may contain pores including air or a material including bubbles. Such a structure allows even a wider range of control of the softness (e.g., Young's modulus). This improves the conformity of the first terminal 500a to the shape of the battery element 1 expanded or contracted, further eliminating problems, such as detachment.

The first conductive material may contain non-flammable and flame-retardant materials, such as an oxide, a ceramic, and a solid electrolyte. This improves heat resistance of the first terminal 500a and provides effects of a layer wall that suppresses spread of fire in case of abnormal heat generation in the battery.

The third conductive material, which is contained in the third terminal 500b in contact with the second electrode 200, may be formed of the material included in the above-described examples of the material usable as the first conductive material.

The first terminal 500a and the third terminal 500b may be formed of the same material or different materials. When the first terminal 500a and the third terminal 500b are formed of different materials from each other, at least the first terminal 500a may be formed of the above-described material and have the above-described physical properties.

### Second Terminal and Fourth Terminal

The second terminal 600a covers at least part of a surface of the first terminal 500a to be electrically connected to the first terminal 500a and directly covers at least part of an end portion of the battery element 1. In other words, the second terminal 600a is in contact with and covers at least part of the end portion of the battery element 1. The second terminal 600a may enclose the first terminal 500a.

The fourth terminal 600b covers at least part of a surface of the third terminal 500b to be electrically connected to the third terminal 500b and directly covers at least part of an end portion of the battery element 1. In other words, the fourth terminal 600b is in contact with and covers at least part of the end portion of the battery element 1. The fourth terminal 600b may enclose the third terminal 500b.

The second terminal 600a and the fourth terminal 600b are in contact with at least part of the end portion of the battery element 1. With this configuration, the second terminal 600a, the end portion of the battery element 1, and the first terminal 500a form a complex joint structure, providing strong connection to each other. This configuration also provides a complex joint structure between the fourth terminal 600b, the end portion of the battery element 1, and the third terminal 500b, resulting in strong connection to each other. This does not require the battery element 1 to be chamfered at the corner, and thus the battery element 1 can have the active material even at the end portion, increasing the capacity of the battery.

### Second Conductive Material and Fourth Conductive Material

The second terminal 600a containing the second conductive material is composed of a conductive material having electron conductivity.

The second conductive material may contain a resin material. This can further reduce entry of moisture at the end portion of the battery element 1 and improve the sealing properties. Furthermore, the elasticity of the second conductive material improves the absorption of stress applied by the mounting board. Stress from the mounting board is caused, for example, by volume change of the battery resulting from charge and discharge, deflection of the mounting board, or impact during mounting.

The second terminal 600a may be formed of a conductive material softer than the material of the first terminal 500a. The second terminal 600a covers the first terminal 500a and the part which is not covered by the first terminal 500a (e.g., the ridge exposed portion 700a of the battery element 1) to connect them to each other. With this configuration, the cushioning properties of the second terminal 600a reduces the stress in the battery caused by charge and discharge and the stress generated between the battery and the mounting board. This enables production of highly reliable surface-mount batteries having high-rate characteristics. The stress between the battery and the mounting board is caused, for example, by thermal expansion and deflection of the mounting board and deformation of the battery caused by charge and discharge.

The second conductive material desirable contains a highly conductive metal as the first conductive material. The second conductive material may contain, for example, at least one of silver, copper, nickel, zinc, aluminum, palladium, gold, platinum, or an alloy of any combination of these metals. When the first conductive material and the second conductive material include a conductive resin material, the metal content of the second conductive material may be lower than that of the first conductive material. This allows formation of a softer terminal than the first conductive material. Furthermore, the conductivity of the first conductive material can be set higher than that of the second conductive material. In this configuration, the first terminal 500a, which is connected to the battery element 1 and extracts the battery characteristics, has a lower resistance, and the second terminal 600a, which is the mount terminal to be connected to the mounting board, is soft. This enables production of a battery that can charge and discharge at a high rate and have high reliability. The second conductive material may be a material that contains conductive particles or semiconductor material particles in a solid electrolyte in addition to the metallic component. This allows a wider range of control of the linear expansion coefficient and hardness and can reduce structural defects between the first terminal 500a and the battery element 1 caused by stress, such as temperature cycling and thermal shock. The second conductive material may be formed of a material containing a conductive resin paste including a constituent of the battery element 1, such as a solid electrolyte, because such a material allows a wider range of control of the thermal expansion coefficient and the softness (e.g., Young's modulus). This can reduce detachment and crack due to temperature cycling or thermal shock.

The resin that can be contained in the second conductive material may be a thermoplastic resin or a thermosetting resin. The second conductive material may contain a thermosetting resin to enable easy formation of the terminal.

The thermoplastic resin and the thermosetting resin may be those used in the first conductive material described above.

The second conductive material may have a different hardness from the first conductive material. With this configuration, the materials can be selected such that the battery characteristics can be extracted with low loss by the first terminal 500a, and the reliability (e.g., stress absorbance during sealing and mounting) can be given by the second terminal 600a formed of the second conductive material. This enables production of a surface-mount battery having high performance and high reliability.

The second conductive material may be softer than the first conductive material. With this configuration, the stress caused during the use of the battery is absorbed mainly by deformation of the second terminal 600a formed of the second conductive material, and the characteristics of the battery element 1 is extracted by the first terminal 500a formed of the first conductive material. This improves not only the stress absorbance and the substrate mounting reliability but also the battery characteristics.

The second conductive material may have higher electrical resistance than the first conductive material. This enables the characteristics of the battery element 1 to be extracted with low loss, enabling production of a highly reliable battery can be produced.

The second terminal 600a may contain pores including air or a material having bubbles, like the first terminal 500a. This structure enables a wider range of control of the softness (e.g., Young's modulus), improving the reliability of the battery 1000 being mounted. As described above, the second terminal 600a may include pores. The pores may include open pores in communication with the outside. This reduces, for example, the possibility that a plating solution that has entered the pores during solder plating will squirt and splash due to heat generated during solder mounting and cause a short circuit. For example, the open pores can be formed during curing if the material contains a component (solvent) having a boiling point lower than or equal to the curing temperature of the thermosetting resin. The second terminal 600a may contain nonflammable materials, such as ceramics and solid electrolytes, for example, in addition to the metal. When the terminal contains a nonflammable or flame-retardant material, the material improves the heat resistance of the terminal and provides effects of a layer wall that suppresses spread of fire in case of abnormal heat in the battery.

In the configuration illustrated in FIGS. 1A and 1B, if each of the first terminal 500a, the second terminal 600a, and the second insulating member 400b includes a resin material, the processing temperature is the lowest for the second conductive material, followed by the first conductive material, and the insulating film. For the thermosetting resin, the processing temperature is, for example, the curing temperature to accelerate thermal curing of the resin. For the thermoplastic resin, the processing temperature is, for example, the phase transition temperature to allow resin flow (e.g., glass transition temperature or melting point). When the insulating film contains a first thermosetting resin, the first conductive material contains a second thermosetting resin, and the second conductive material contains a third thermosetting resin, for example, the curing temperature of the first thermosetting resin is greater than or equal to the curing temperature of the second thermosetting resin, and the curing temperature of the second thermosetting resin is greater than or equal to the curing temperature of the third thermosetting resin. This allows the curing temperature of the first conductive material to be lower than or equal to the curing temperature of the first thermosetting resin contained in the insulating film and also allows the curing temperature of the second conductive material to be lower than or equal to the curing temperature of the second thermosetting resin contained in the first conductive material. This enables formation of the terminals with less degradation of the properties of the insulating film and the first conductive material and with less detachment and crack generation. When the first terminal 500a is formed by baking and each of the second terminal and the insulating film contains a resin material, the processing temperature of the resin of the second conductive material may be lower than that of the insulating film. Thus, the curing temperature of the thermosetting resin of the insulating film is higher than or equal to the curing temperature of the thermosetting resin of the second conductive material.

The fourth conductive material, which is contained in the fourth terminal 600b, may be formed of the material included in the above-described examples of the material usable as the second conductive material.

### Second Embodiment

Hereinafter, a battery 2000 according to a second embodiment will be described. The features described in the above-described embodiment may be omitted.

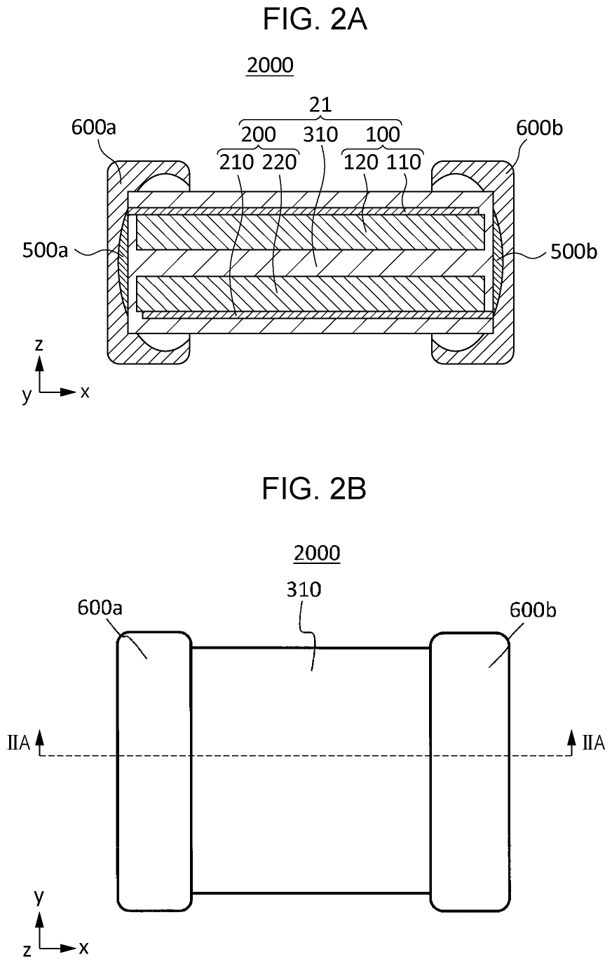

FIGS. 2A and 2B each illustrate a schematic configuration of the battery 2000 according to the second embodiment. FIG. 2A is a cross-sectional view illustrating a schematic configuration of the battery 2000 according to the second embodiment viewed in the y axis direction. FIG. 2B is a plan view illustrating a schematic configuration of the battery 2000 according to the second embodiment viewed in the z axis direction. FIG. 2A illustrates a cross section taken along line IIA-IIA in FIG. 2B.

As illustrated in FIGS. 2A and 2B, the battery 2000 according to the second embodiment includes a battery element 21 in which the entire first electrode 100 and the entire second electrode 200 are in a solid electrolyte layer 310. The solid electrolyte layer 310 is, for example, an oxide solid electrolyte. Thus, the battery 2000 according to the second embodiment differs from the battery 1000 according to the first embodiment in the configuration of the battery element 21.

Examples of the oxide solid electrolyte constituting the solid electrolyte layer 310 include known oxide solid electrolytes having high atmospheric stability, such as crystallized LAGP glass (Li_{1.5}Al_{0.5}Ge_{1.5} (PO₄)₃) and garnet-type LLZ (Li₇La₃Zr₂O₁₂).

Like the battery 1000 according to the first embodiment, the battery 2000 according to the second embodiment includes a first terminal 500a being in contact with the first electrode 100, and a second terminal 600a covering at least part of a surface of the first terminal 500a to be electrically connected to the first terminal 500a and directly covering at least part of the end portion of the battery element 21. In the battery 2000 illustrated in FIG. 2A, the first terminal 500a is in contact with the first current collector 110. The second terminal 600a is in contact with and covers the battery element 21 at the corner of the end portion of the battery element 21 not covered by the first terminal 500a.

Furthermore, like the battery 1000 according to the first embodiment, the battery 2000 according to the second embodiment includes a third terminal 500b being in contact with the second electrode 200, and a fourth terminal 600b covering at least part of a surface of the third terminal 500b to be electrically connected to the third terminal 500b and directly covering at least part of an end portion of the battery element 21. In the battery 2000 illustrated in FIG. 2A, the third terminal 500b is in contact with the second current collector 210. The fourth terminal 600b is in contact with and covers the battery element 21 at the corner of the end portion of the battery element 21 not covered by the third terminal 500b.

The first terminal 500a, the second terminal 600a, the third terminal 500b, and the fourth terminal 600b of the battery 2000 according to the second embodiment may be the same as the first terminal 500a, the second terminal 600a, the third terminal 500b, and the fourth terminal 600b of the first embodiment, respectively.

For example, in the battery 2000 according to the second embodiment, as an example of the first terminal 500a, an electrode paste containing Cu powder particles of a highly conductive metal material (for example, Cu particles having a particle diameter of 0.3 to 1 μm) and a glass fit powder (any known one, such as SiO₂—Bi₂O₃—B₂O₃—ZnO (having a softening point of 500 to 550° C., for example)) is applied on an end surface, and then baked at a temperature of 550 to 600° C., which is higher than or equal to the softening point of the glass frit, in a nitrogen atmosphere that does not allow oxidation of Cu. The glass component diffuses into the underlying solid oxide electrolyte when baked and forms a diffusion layer through the reaction. In addition to the anchor effect, this also provides a strong bond between the first conductive material and the solid oxide electrolyte. The first terminal 500a has a thickness of 1 to 10 μm, for example. When the thickness is greater than or equal to 1 μm, the baked metal film is less likely to shrink into an island shape during the sintering, allowing easy formation of a continuous conductive film. When the thickness is less than or equal to 10 μm, the metal film does not become too thick, reducing the possibility that the metal film will be readily detached from the battery element 21 by extraction or contraction due to charge and discharge or temperature cycling. The third terminal 500b can have the same configuration as the first terminal 500a.

In the battery 2000 according to the second embodiment, an example of the second conductive material contained in the second terminal 600a is a thermosetting epoxy conductive resin material containing Ag particles (e.g., Ag particles having a particle diameter of 0.3 to 1 μm). This conductive resin material may be applied and cured at about 200° C. in nitrogen, for example, to form the second terminal 600a. The second terminal 600a is softer than the first terminal 500a, which is formed of the electrode paste containing Cu powder particles and the glass fit powder as described above. This configuration can reduce expansion and contraction due to charge and discharge and reduce stress applied by the mounting board while extracting the battery characteristics. The second terminal 600a may have a thickness of 1 to 10 μm. The thickness of the second terminal 600a may be suitably set in view of stress reduction. If the second terminal 600a is too thick, the volumetric energy density decreases, and thus the second terminal 600a should have a proper thickness. A thermosetting conductive resin may be applied and cured by heat treatment in nitrogen to form the second terminal 600a. This heat treatment in a non-oxidizing atmosphere can reduce the surface oxidation of metal particles contained in the second conductive material, reducing a decrease in the connection resistance during mounting and deterioration of solder wettability. The fourth terminal 600b can have the same configuration as the second terminal 600a.

In the battery 2000 according to the second embodiment, the active material layer can extend to the end portion of the cuboid, although the end portions of common chip components are chamfered and removed. Thus, the battery 2000 can have a larger capacity. The end portion of the battery 2000 is covered, for example, by a relatively soft second terminal 600a, reducing the problem of easy chipping. The second terminal 600a is bonded to two surfaces of different materials, i.e., the first terminal 500a and the solid electrolyte layer 310 of the battery element 21, providing a complex joint structure similar to that of the battery 1000 according to the first embodiment, and thus the connection is strong.

As described above, the battery 2000 according to the second embodiment also has the same effect as the battery 1000 according to the first embodiment.

### Third Embodiment

Hereinafter, a battery 3000 according to a third embodiment will be described. The features described in the above-described embodiments may be omitted.

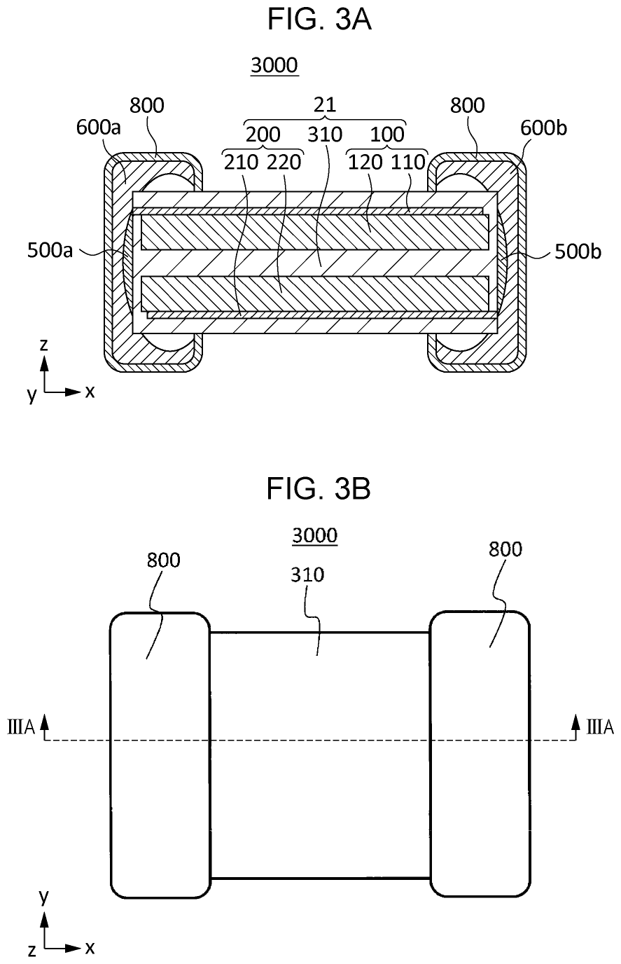

FIGS. 3A and 3B each illustrate a schematic configuration of the battery 3000 according to the third embodiment. FIG. 3A is a cross-sectional view illustrating a schematic configuration of the battery 3000 according to the third embodiment viewed in the y axis direction. FIG. 3B is a plan view illustrating a schematic configuration of the battery 3000 according to the third embodiment viewed in the z axis direction. FIG. 3A illustrates a cross section taken along line IIIA-IIIA in FIG. 3B.

As illustrated in FIGS. 3A and 3B, the battery 3000 according to the third embodiment has a solder plating film 800 on a surface of the second terminal 600a. In other words, the battery 3000 according to the third embodiment further has a soldering material in addition to the components of the battery 2000. In the battery 3000 according to the third embodiment, the fourth terminal 600b also has the solder plating film 800 on the surface. The battery 3000 according to the third embodiment has the same configuration as the battery 2000 according to the second embodiment, except for the solder plating film 800. Examples of the solder plating include, for example, Sn plating on a Ni underlayer.

As described above, the battery 3000 includes a soldering material on the second and fourth terminals 600a and 600b. This enables the battery 3000 to be mounted on a mounting board by soldering as a common surface-mount component, for example, by a process, such as a widely used reflow soldering process. This configuration enables easy surface mounting of a high-performance and highly reliable battery, and the battery can be mounted on a substrate as other commonly used surface-mount components, such as multilayer ceramic capacitors (MLCCs), and thus this configuration has high industrial value.

The solder plating can be formed, for example, by electrolytic plating, such as barrel plating, which is commonly used for chip components. For example, the Ni underlayer has a thickness of 0.5 to 5 μm, and Sn has a thickness of 0.5 to 5 μm. The Ni film should have no defects (e.g., cracks and voids). If the Ni film is too thick, the film stress during film formation may be large and cause cracks in the substrate. Furthermore, the thickness of Sn is not limited, but if Sn is too thick, the Ni film may have cracks during temperature cycling. This may adversely affect the solder wettability and lower the volumetric energy density. For this reason, the plating thickness should be set appropriately. The composition of the solder plating film is not limited to Sn. Any known soldering material, such as a non-lead-based composition and a lead-based composition, which is used for board mounting and has high solder wettability, can be used.

### Fourth Embodiment

Hereinafter, a battery 4000 according to a fourth embodiment will be described. The features described in the above-described embodiments may be omitted.

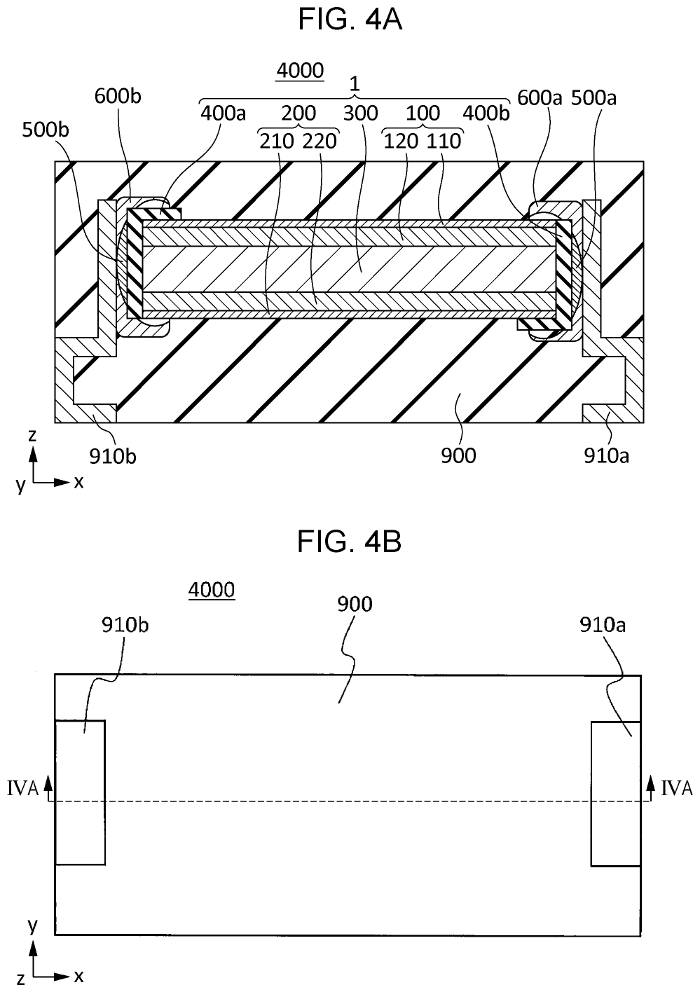

FIGS. 4A and 4B each illustrate a schematic configuration of the battery 4000 according to the fourth embodiment. FIG. 4A is a cross-sectional view illustrating a schematic configuration of the battery 4000 according to the fourth embodiment viewed in the y axis direction. FIG. 4B is a plan view illustrating a schematic configuration of the battery 4000 according to the fourth embodiment viewed from below in the z axis direction. FIG. 4A illustrates a cross section taken along line IVA-IVA in FIG. 4B.

As illustrated in FIGS. 4A and 4B, the battery 4000 according to the fourth embodiment differs from the battery 1000 in that a second insulating member 900, a lead terminal 910a, and a lead terminal 910b are included. The lead terminals 910a and 910b are soldered to the second and fourth terminals 600a and 600b, respectively. The second insulating member 900 encloses the battery element 1, the first terminal 500a, the second terminal 600a, the third terminal 500b, and the fourth terminal 600b. The lead terminals 910a and 910b each have at least part located outside the second insulating member 900 as mounting terminals.

The above-described configuration can provide a compact and highly reliable surface-mount battery.

The second insulating member 900 can be formed of the same insulating resin as the above-described insulating member, such as a thermosetting epoxy resin, which is a molding resin capable of blocking air and moisture entering devices or the like. The external terminal portion of the lead terminal (i.e., the portion exposed by the second insulating member 900) may be partially solder plated (e.g., Sn-based, 1 μm thick solder plating) on a 0.3 mm thick SUS plate, for example. After soldering of the lead terminals 910a and 910b to the second and fourth terminals 600a and 600b, respectively, it is put in a thermosetting epoxy resin solution casted in a mold and thermally cured at a temperature of 200 to 240° C., for example, to produce the battery 4000. This configuration enables surface mount by reflow soldering, for example.

The lead terminals 910a and 910b may be formed of stainless steel (SUS), for example.

As above, when the battery 4000 is enclosed in the mold resin, i.e., the second insulating member 900, the lead terminals 910a and 910b can also absorb the stress caused by deflection of the board or by volume change of the mounting board caused by charge and discharge or temperature cycling. This further improves stress absorption and increases impact resistance and the connection durability. The molded insulating resin also acts as a protective layer of the battery 4000 and improves environmental resistance (e.g., moisture resistance). The mounting portion of the lead terminal may be solder plated, for example, to enable solder mounting, such as reflow soldering.

### Fifth Embodiment

Hereinafter, a battery 5000 according to a fifth embodiment will be described. The features described in the above-described embodiments may be omitted.

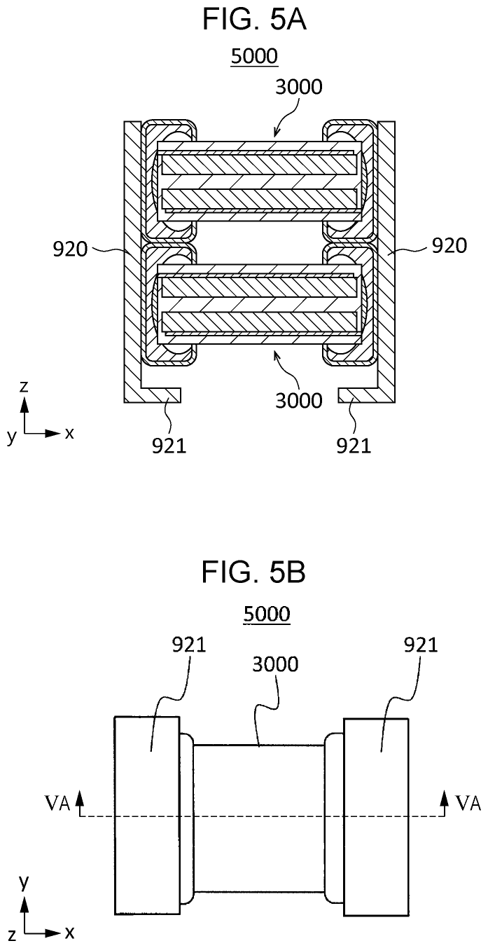

FIGS. 5A and 5B each illustrate a schematic configuration of the battery 5000 according to the fifth embodiment. FIG. 5A is a cross-sectional view illustrating a schematic configuration of the battery 5000 according to the fifth embodiment viewed in the y axis direction. FIG. 5B is a plan view illustrating a schematic configuration of the battery 5000 according to the fifth embodiment viewed from below in the z axis direction. FIG. 5A illustrates a cross section taken along line VA-VA in FIG. 5B.

As illustrated in FIGS. 5A and 5B, the battery 5000 according to the fifth embodiment includes two batteries 3000 stacked on top of another. In other words, the battery 5000 differs from the battery 3000 according to the third embodiment in that the battery 5000 includes multiple cells. As described in the third embodiment, the battery 3000 illustrated in FIG. 3A includes the solder plating films 800 on the surfaces of the second terminal 600a and the fourth terminal 600b. The battery 5000 includes lead terminals 920 bonded to the solder plating films 800.

The lead terminal 920 is formed, for example, of a plate-shaped conductive member, such as a plate-shaped member made of stainless steel (SUS) having a thickness of 0.3 mm.

The batteries 3000, which are cells included in the battery 5000, may be connected in series with each other.

The lead terminals 920 are plate-shaped members, for example, as described above, and are bonded to the solder plating films 800 on the surfaces of the second and fourth terminals of the battery 3000, with, for example, Sn-based solder. The lower portion of the lead terminal 920 is a mounting terminal 921 to be mounted on the mounting board. The mounting terminal 921 is formed by bending the plate-shaped member forming the lead terminal 920 to extend substantially parallel to the main surface of the battery 3000. This enables the battery 3000 to be bonded to the mounting board via the plate-shaped member forming the lead terminal 920 when the battery 3000 is mounted. The solder used for bonding between the lead terminal 920 and the battery 3000 desirable has a higher melting point than the solder used for mounting. This prevents disconnection between the second terminal of the battery 3000 and the lead terminal 920 during mounting, resulting in highly reliable mounting.

The lower portion of the battery 5000 may be away from the mounting board. This prevents the battery 5000 from directly coming into contact with the mounting board when the mounting board is largely deflected, and the lead terminal 920 can absorb the deflection of the mounting board by being deformed. This configuration also enables the battery 5000 to have a higher deflection resistance, further improving the reliability of the high-performance battery.

### Method of Producing Battery

The following is an example of a method of producing a battery according to the present disclosure. A method of producing the battery 1000 according to the first embodiment will be described as an example.

In the following description, the first electrode 100 is a positive electrode, and the second electrode 200 is a negative electrode.

First, pastes used for printing the first active material layer 120 (hereinafter referred to as the positive electrode active material layer) and the second active material layer 220 (hereinafter referred to as the negative electrode active material layer) are produced. A glass powder of Li₂S—P₂S₅ sulfide having an average particle diameter of about 10 μm and mainly composed of a triclinic crystal is provided as the solid electrolyte raw material used for the composite material of each of the positive electrode active material layer and the negative electrode active material layer, for example. The glass powder has high ionic conductivity, for example, of about 2×10⁻³ to 3×10⁻³ S/cm. A powder of layered Li—Ni—Co—Al composite oxide (LiNi_{0.8}Co_{0.15}Al_{0.05}O₂) having an average particle diameter of about 5 μm is used as the positive electrode active material, for example. The composite material including the above-described positive electrode active material and the above-described glass powder is dispersed in an organic solvent or the like to produce a paste for the positive electrode active material layer. A natural graphite powder having an average particle diameter of about 10 μm is used as the negative electrode active material, for example. The composite material including the above-described negative electrode active material and the above-described glass powder is dispersed in an organic solvent or the like to produce a paste for the negative electrode active material layer.

Next, copper foils each having a thickness of about 15 μm, for example, are provided as the material of the first current collector 110 (hereinafter referred to as the positive electrode current collector) and the material of the second current collector 210 (hereinafter referred to as the negative electrode current collector). For example, by using a screen-printing method, the paste for the positive electrode active material layer is printed on a surface of a copper foil, and the paste for the negative electrode active material layer is printed on a surface of a copper foil, in a predetermined shape and at a thickness of about greater than or equal to 50 μm and less than or equal to 100 μm. The pastes for the positive electrode active material layer and the negative electrode active material layer are dried at greater than or equal to 80° C. and less than or equal to 130° C. to have a thickness of greater than or equal to 30 μm and less than or equal to 60 μm. In this way, the positive electrode active material layer is formed on the positive electrode current collector, and the negative electrode active material layer is formed on the negative electrode current collector.

Next, the composite material containing the above-described glass powder is dispersed in an organic solvent or the like to produce a paste for the solid electrolyte layer. On the positive electrode and the negative electrode, the above-described paste for the solid electrolyte layer is printed at a thickness of, for example, about 100 μm using a metal mask. Then, the positive electrode and the negative electrode, on each of which the paste for the solid electrolyte layer is printed, are dried at greater than or equal to 80° C. and less than or equal to 130° C.

Next, the positive electrode and the negative electrode are stacked with the printed solid electrolytes facing each other and being in contact with each other.

Next, the stack is pressurized with a pressure die. Specifically, an elastic sheet having a thickness of about 70 μm and an elastic modulus of about 5×10 6 Pa, for example, is interposed between the stack and the pressure die plate, in other words, on the top surface of the current collector of the stack. With this configuration, the stack is subjected to pressure with the elastic sheet interposed therebetween. Then, the stack is pressurized for 90 seconds while the pressure die is heated to 50° C. at a pressure of 300 MPa. In this way, the battery element 1 is produced.

Next, a thermosetting epoxy resin is applied at a thickness of about 20 to 40 μm by screen printing onto the end surfaces (both short-side surfaces) of the battery element produced as described above. A portion extended to a long-side portion is also formed at the same time. The thermosetting epoxy resin is then cured at a temperature of about 120 to 150° C. for 1 to 3 hours. This is repeated twice to form insulating films (i.e., the first side surface covering portion 410a and the second side surface covering portion 410b of the insulating member) each having a laminated structure having a thickness of about 30 to 60 μm.

Then, the thermosetting epoxy resin is applied by screen printing at a thickness of about 10 μm and cured at about 120 to 150° C. for 1 to 3 hours to form portions extended to the main surface (the first main surface covering portion 420a and the second main surface covering portion 420b). Next, a thermosetting conductive paste containing Ag particles having an average particle diameter of 0.5 μm is screen-printed at a thickness of about 30 μm on the first main surface 2 and the second main surface 3 of the battery element 1 produced as described above and patterned to form the electrode contact portion 520a of the first terminal 500a and the electrode contact portion 520b of the third terminal 500b. Furthermore, a thermosetting conductive paste containing Ag particles is screen-printed on the first insulating member 400a of the first side surface 4 and the second insulating member 400b of the second side surface 5 of the battery element 1 at a thickness of about 30 μm, except for the ridge exposed portions 700a and 700b. The thermosetting conductive paste is cured at a temperature of less than or equal to the curing temperature of the insulating member, for example, at a temperature of 120 to 130° C., for 0.5 to 3 hours to form the first terminal 500a and the third terminal 500b. At this time, the first terminal 500a and the third terminal 500b each may be formed in layers as necessary to have a predetermined thickness. Next, a thermosetting conductive paste containing Ag particles having a lower Ag content than those used to form the first terminal 500a and the third terminal 500b is applied as the second conductive material to cover the outer surfaces of the first and third terminals 500a and 500b, for example, and is cured at a temperature of 100 to 120° C. for 0.5 to 3 hours to form the second and fourth terminals 600a and 600b.

The battery 1000 is produced in this way. After the production, the areas other than the second and fourth terminals 600a and 600b may be subjected to resist processing, and Sn-based solder plating (e.g., 3 to 7 μm thick solder plating) with a Ni underlayer (e.g., Ni underlayer having a thickness of 1 to 2 μm) may be applied by electrolytic plating.

The method of forming the battery 1000 and the order of steps are not limited to the above-described examples.

In the above-described production method, the paste for the positive electrode active material layer, the paste for the negative electrode active material layer, the paste for the solid electrolyte layer, and the conductive paste are applied by printing, but the production method is not limited to this example. Non-limiting examples of the printing method include a doctor blade method, a calender method, a spin coat method, a dip coat method, an inkjet method, an offset method, a die coat method, and a spray method.

In the above-described production method, a thermosetting conductive paste containing Ag metal particles is used as the conductive paste, but the conductive paste is not limited to this example. Any resin that can function as a bonding binder may be used as the thermosetting conductive paste, and a resin is selected in view of printability and coatability depending on the employed production process. Examples of the resin used in the thermosetting conductive paste include a thermosetting resin. Non-limiting examples of the thermosetting resins include (i) amino resin, such as urea resin, melamine resin, and guanamine resin, (ii) epoxy resin, such as bisphenol A epoxy resin, bisphenol F epoxy resin, phenolic novolac epoxy resin, and cyclic epoxy resin, (iii) oxetane resin, (iv) resol phenolic resin and novolac phenolic resin, and (v) silicone-modified organic resin, such as silicone epoxy resin and silicone polyester resin. The resin may include only one of these materials or two or more of these materials in combination.

The battery according to the present disclosure may be used as a secondary battery, such as a surface mount all-solid-state battery for various electronic devices and automobiles, for example.

What is claimed is:

1. A battery comprising:
a battery element including a first electrode, a solid electrolyte layer, and a second electrode;
a first terminal containing a first conductive material; and
a second terminal containing a second conductive material,
wherein the first terminal is in contact with the first electrode, and
the second terminal covers at least part of a surface of the first terminal to be electrically connected to the first terminal and directly covers at least part of a corner of the battery element.

2. The battery according to claim 1, wherein the second terminal encloses the first terminal.

3. The battery according to claim 1, wherein the first conductive material is a sintered material containing metal.

4. The battery according to claim 1, wherein the first conductive material is a sintered material containing glass.

5. The battery according to claim 4, wherein the first conductive material is a sintered material containing two or more kinds of glass.

6. The battery according to claim 4, wherein the glass has a compacted powder structure and a molten structure.

7. The battery according to claim 1, wherein the first conductive material contains a resin material.

8. The battery according to claim 1, wherein the first conductive material contains an oxide.

9. The battery according to claim 1, wherein the second conductive material contains a resin material.

10. The battery according to claim 1, wherein the second conductive material has a different hardness from the first conductive material.

11. The battery according to claim 1, wherein the second conductive material is softer than the first conductive material.

12. The battery according to claim 1, wherein the second conductive material has a higher electrical resistance than the first conductive material.

13. The battery according to claim 1, wherein the second conductive material has pores.

14. The battery according to claim 13, wherein the pores include open pores.

15. The battery according to claim 1, further comprising a soldering material, wherein
the soldering material is in contact with the second terminal.

16. The battery according to claim 1, further comprising an insulating member, wherein
the insulating member encloses the battery element, the first terminal, and the second terminal.

17. The battery according to claim 1, further comprising:
a third terminal containing a third conductive material: and
a fourth terminal containing a fourth conductive material,
wherein the third terminal is in contact with the second electrode, and
the fourth terminal covers at least part of a surface of the third terminal to be electrically connected to the third terminal and directly covers at least part of an end portion of the battery element.
